(19) United States
(12) Patent Application Publication
(10) Pub. No.: US 2010/0058935 A1
(43) Pub. Date: Mar. 11, 2010

(54) AUTOMATIC CONTINUOUS DOUGH FRYING UNIT EQUIPPED WITH DOUGH FEEDER FOR MAKING DEEP-FRIED PASTRIES

(76) Inventor: ISTVAN JANOSI, Budapest (HU)

Correspondence Address: Hershkovitz & Associates, LLC, 2845 Duke Street, Alexandria, VA, 22314, US

(21) Appl. No.: 12/522,915

(22) PCT Filed: Feb. 13, 2008
(86) PCT No.: PCT/HU08/00014

§ 371 Date: Jul. 10, 2009

(30) Foreign Application Priority Data
Feb. 28, 2007 (HU) P0700179

(51) Int. Cl. A21B 5/08; A47J 37/12

(52) U.S. Cl. 99/354; 99/355; 99/407; 99/409

(57) ABSTRACT

The present disclosure relates to an automatic continuous dough frying unit for making deep-fried pastries having mechanisms for dispensing, transferring, turning and outputting the dough to be fried.

### CROSS-REFERENCE TO RELATED APPLICATIONS

This application is a U.S. National Stage submission under 35 U.S.C. § 371 of International Application Number PCT/HU08/00014 having an international filing date of Feb. 13, 2008, and having a priority date of Feb. 28, 2007.

### BACKGROUND OF THE DISCLOSURE

1. Field of the Disclosure

The subject matter of the invention is an automatic continuous dough frying unit for making deep-fried pastries having mechanisms for dispensing, transferring, turning and outputting the dough to be fried.

2. Discussion of Background Information

Special machines have been in use for a long time to make deep-fried pastries, especially doughnuts, which are popular worldwide. Such machines are usually equipped with conveyor belts immersed in fat. The uncooked dough is placed on one end, the half done doughnuts are flipped over halfway on the conveyor belt and the finished doughnuts are removed at the other end. EP 0 212 658 A2 describes such a machine, for example.

In another solution, which is described in the publication document associated with patent application No. HU P9101449, the frying process is accelerated by way of the conveyor being fully immersed, so the doughnut is fried at once without needing to flip it over. This solution, however, fails to provide doughnuts of appropriate quality because the conveyor belt prevents the top side from frying properly.

The advantage of such units is that they are able to fulfill the demand where large quantities of doughnuts must be produced. They have a disadvantage, however, in that they require a great amount of space since the raw dough travels in a straight line from one end of the frying pan to the other. In other words, a remarkably large hot oil pan is required. These units are typically uneconomical and include non-enclosed equipment so they pollute the environment considerably.

OTEX Kft. (Debrecen, Hungary) makes a doughnut frying unit for preparing small quantities of doughnuts. In this unit the doughnuts are fried in four stages. In the first stage a feeding mechanism dispenses the raw soft dough. In the second stage the dough is put into the hot oil in which one half of it is fried while floating therein. In the third stage the half done doughnuts are flipped and the other half is fried in the end of the frying pan. In the fourth stage the machine removes the cooked doughnuts, drains off the surplus oil and the doughnuts are removed from the fryer. Thus, in each stage the doughnut remains in place but once a stage has been completed, it proceeds forward in a straight line. The quantity to be produced at once can be increased by adding several of such process lines, i.e., by increasing the width of the unit.

An advantage of this unit is that it requires a significantly smaller frying pan and accordingly less fat than in equipments that employ conveyor belts. Its advantage is that, whenever pastries with a larger diameter than a doughnut are to be fried, the length of the line incorporating the four stages will grow proportionally with the diameter, and placement of the machine—on account of its size—will be problematic even if small quantities are involved.

Such equipments, however, no longer meet the modern requirements because they are opened therefore subjects to two-way environmental contamination. Additionally, they usually cannot be operated indoors due to the readily evaporating oil and they are subject to contamination from the outside when set up outdoors (open markets, fairs, etc.). On the other hand, they waste energy because cooking in an appliance with an open pan consumes 30-50% more energy than preparing food in an enclosed apparatus.

Automatic units have been in use for a long time for deep-frying foods. Particularly popular is the preparation of French fries consisting of small pieces using such appliances. Patent application No. WO 2005/063097 A2 describes such an automatic appliance, for example, where the raw food is loaded into a perforated basket, the basket is lowered into a hot oil frying pan, and the basket is rotated in order to ensure that the food is fried on all sides. Such automatic units are only suitable for frying small batches at a time, so they are only used in small catering establishments.

Automatic units where baskets rotate inside a circular frying pan are used to make fried foods continuously. The rotation rate is determined so that the raw food can be loaded, fried and then removed from the basket when done in the amount of time it takes the basket to return to its loading position. Patent description No. U.S. Pat. No. 5,228,382, for example, describes such a unit, where the movement of the basket in the frying pan ensures the turning of the food and thus its frying on all sides.

There are foods, however, which do not sink in the frying pan but fry while floating on the surface thereof. They must be turned over once while frying. The alternatives mentioned are unsuitable for frying such foods. Popular worldwide, the doughnut is such a deep-fried pastry, fried while floating oil, and special machines have been used to make them.

It is also known that automatic units have been used to make shaped foods such as noodles. Publication document No. DE 197 38 996 A1 describes such a unit, for example. Inside the vertically arranged apparatus, the raw dough is prepared by mixing and kneading in a raw dough feeder above, then a sheave below it dispenses the raw dough into a feeder opening at the bottom part of the unit. The removal, transfer to the frying point and loading of the finished shaped dough is done manually or by means independent from the unit.

### SUMMARY OF THE DISCLOSURE

The objective of the invention is, apart from retaining the advantages of known solutions, to design an automatic unit, which allows a continuous output of finished product even with langosh sized, deep-fried pastry varieties and thus allows it to be used in large catering establishments.

The basis of the invention is the recognition that if raw dough is fed and the fried dough is not removed by horizontally rotating the dough placed on the frying plate in and out, but by advancing the frying plate and the mechanisms that move it during each frying stage, the number of dough pieces that can be fried at any given frying cycle can be increased proportionally if the number of frying plates and the mechanisms that move them is increased.

In one embodiment of the invention:
there are three, preferably four frying plates in the automatic unit which are
placed concentrically on a vertical support column in a plane perpendicular to the column, can be rotated around the support column, can be rotated around their midline perpendicular to the support column, can slide along the support column and can be fixed in an arrested state at the end points, and
arresters of conventional design are fastened to the frying plates, which allow the safe flipping over and transfer of the dough on the frying plates.

### BRIEF DESCRIPTION OF THE DRAWINGS

The invention is demonstrated in greater detail through figures where:

FIG. 1 shows a vertical section of an implementation of the invention,

FIG. 2 shows a section of FIG. 1 along line AA,

FIG. 3 shows a section of an implementation of the dough feeder along line B-B,

FIG. 4 shows a section of FIG. 3 along line C-C,

FIG. 5 shows a section of FIG. 4 along line D-D,

FIG. 6 shows an enlarged detail E of FIG. 1,

FIG. 7 shows an enlarged detail F of FIG. 2,

FIG. 8 shows the bevel gear drive described in FIG. 7, and

FIG. 9 shows the design of the guide track.

### DETAILED DESCRIPTION OF PREFERRED EMBODIMENTS

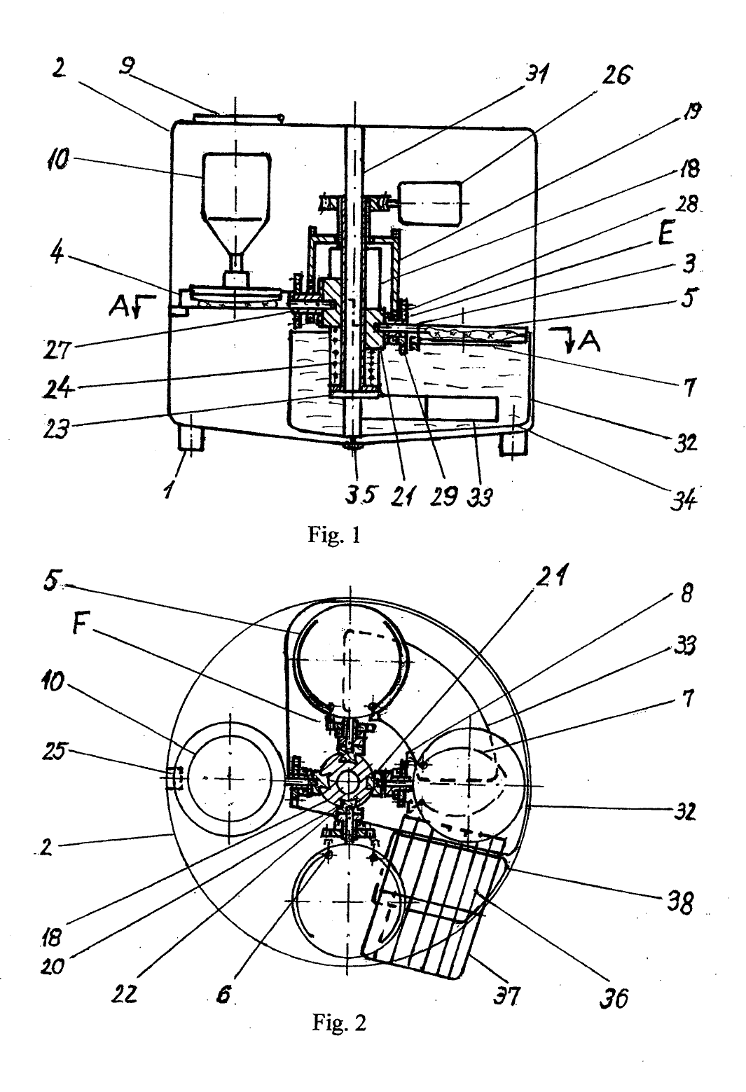

According to the example described in FIGS. 1 and 2, the automatic continuous dough frying unit possesses a heat-insulated and preferably cylindrical casing 2 which stands on legs 1. In the axis of symmetry of the casing 2 there are four identical, circular and perforated frying plates 5 with cylindrical lateral walls, which can be rotated around or fixed in a stationary position on the support column 3 affixed to the casing 2 and which are arranged at a 90-degree angle relative to each other. There is an arrester of conventional design arranged at the free end of the lateral wall of the frying plate 5, which allows the safe flipping over of the dough on the frying plate 5. The arrester in the example comprises two arms 7 that can be rotated inwardly like scissors in a plane parallel to the frying plate 5 around shafts 6 attached to the frying plate 5 at one end. In the open position they comprise arcs of 110-130 degrees in length and loosely fit to the lateral wall of the frying plate 5, and their movement is controlled by a track 8 as described in the example.

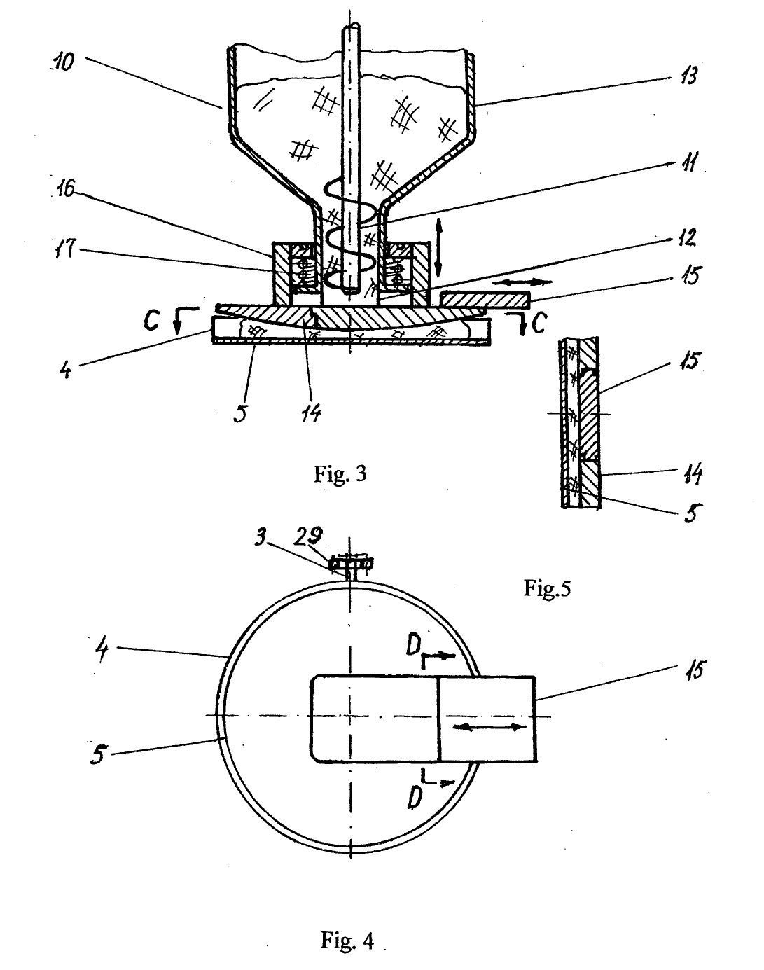

There is a dough feeder opening 9 in the cover of casing 2, under which there is a dough feeder 10 fastened to the casing 2 with an axis preferably common with the opening 9 and parallel with the axis of the automatic unit and located between the opening 9 and the frying plate 5. The conical end of the feeding sheave 11 of the soft dough feeder 10 described in detail in FIGS. 3-5 continues in a cylinder whose inner diameter corresponds in size to the diameter of the feeder sheave 11, ends in a feeder opening 12 and is fitted with a soft dough receiver 13. The feeder opening 12 is sealed by a locking plate 14 consisting of two parts, and the upper of the locking plate 14, preferably flat surface is of a diameter exceeding that of the dough to be prepared, while its lower surface is shaped to allow forming of the soft dough by pressure. In the case of preparing langosh, where the preparation is thin on the inside and thicker toward the edge, the lower surface of the locking plate 14 is convex. Of course, changing the shape of the lower surface of the locking plate 14 can vary the shape of the dough.

There is a slider 15 arranged in the locking plate 14 whose radius is preferably perpendicular to the axis of the support column 3, which can be pushed in and out from the locking plate 14. An actuator of conventional design, which is not pictured, can move the locking plate 14 vertically. Resetting the locking plate 14 is done by a spring 17 inside a spring housing 16 attached to the top of the locking plate 14.

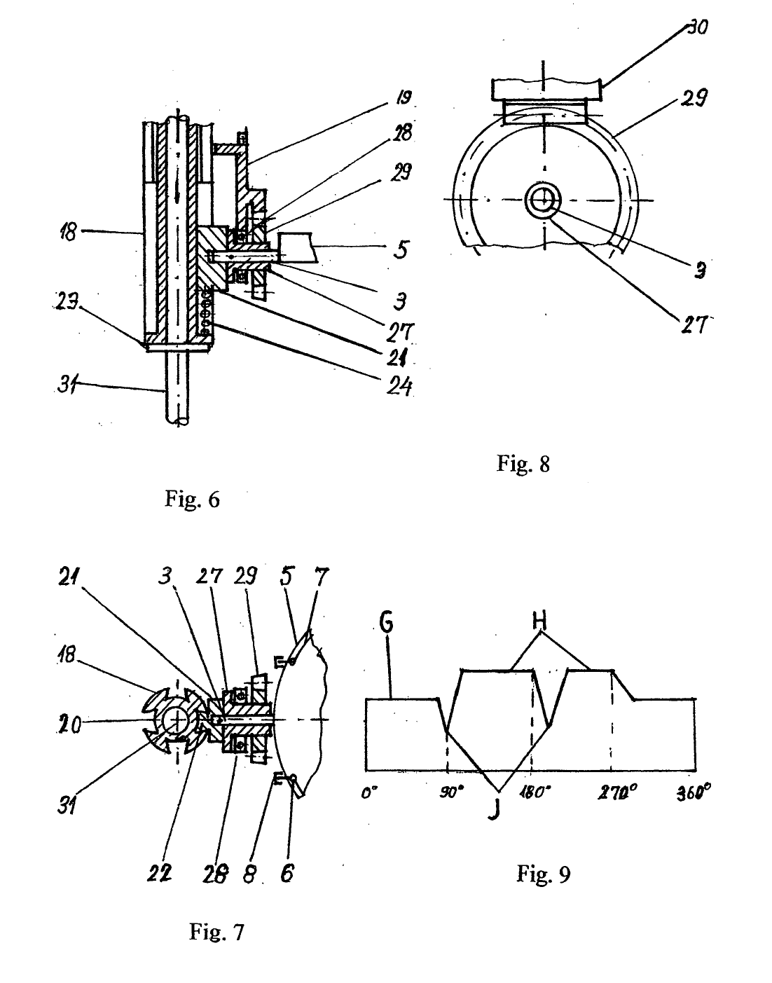

According to details E and F shown in FIGS. 6 and 7, respectively, there is a central rotating bushing 18 on the support column 3, and on the top part of the rotating bushing 18 there is a guiding track 19, arranged in a fixed fashion relative to the casing 2 and shown in outstretched view in FIG. 9, whose lower part, as shown in the example, possesses four dovetail-shaped grooves 20 on its lateral wall at 90-degree angles relative to each other. Extending into each of the grooves 20, are the dovetail ribs 22 of support carriage 21 of the frying plate 5. The dovetail ribs 22 are forced into the guiding track 19 by springs 24 located between the dovetail ribs 22 in the grooves 20 and the lower flange 23 of the central rotating bushing 18. The lower flange 23 bears against a support 25 fastened to the support column 3 allowing it to rotate. The rotation of the central rotating bushing 18 is done by a motor 26 preferably via a worm-gear drive.

A frying plate bushing 27 is connected via a common shaft to the frying plate support carriage 20. The frying plate bushing 27 is seated—via a ball bearing 28 placed on it—in the guiding track 19 that lowers and raises the frying plate 5, which is shown in outstretched view in FIG. 9. The frying plate bushing 27 is connected—likewise via a gear 29 placed on it—to a rack 30 with teeth on its lower surface that provides for a 180-degree rotation in each direction around the diameter of the frying plate5, which is attached to the guiding track 19. This connection is shown in FIG. 8. The frying plate 5 is attached to the frying plate support carriage 21 and the frying plate bushing 27 via shafts 31.

FIG. 2 shows that the frying pan 32 of the automatic continuous dough frying unit subject to the invention is located in the space below the frying plates 5 in upper and right hand position shown in stages two and three. There is an electric heating element 33 on the bottom of the frying pan 32 and there is an oil drain opening 35 on the bottom plate 34 of the frying pan 32, which can be screwed shut and leads through the casing 2. A detachable fried dough tray 36 can be attached to the outside of the casing 2, which works with a drip pan 37 fashioned into a chute that facilitates removal of the fried dough once the frying process has been completed. There is a waste tray 38 on the bottom of the casing 2, which catches any oil dripping off the frying plates and associated mechanisms, and it is designed to be removed from the casing 2 and cleaned.

Provided that the central drive mechanism is designed appropriately, the automatic unit can also be implemented as a three-stage automatic unit featuring three concentrically located frying plates 5. In this case, the frying plate is driven directly below the dough feeder once the other side of the dough piece is fried and the surplus oil has dripped off. By installing six or eight concentric frying plates in the automatic unit, the quantity of fried dough pieces output at any given time can be doubled.

The automatic continuous dough frying unit in the example can be operated as follows when making langosh:

Once the unit is switched on, power from the grid powers the electric heating element 33, which heats the oil in the filled up frying pan 32 to 180-190° C. A conventional thermostat sets the temperature. The automatic continuous dough frying unit in the example can prepare four langosh pastries in one complete revolution. Each langosh is prepared in four stages during which the frying plates 5 rotate by 90 degrees horizontally in each stage, as well as rotating trough their respective horizontal axes by 180 degrees between the second and third and the third and fourth stages. The four stages are as follows: dispensing, frying on one side, frying on the other side and outputting the finished langosh after dripping off the surplus oil. FIG. 2 shows the four frying plates 5 when rotated during the stages.

Dispensing takes place in the first phase. At the beginning of the stage the frying plate 5 returns from its previous position in stage four by horizontally rotating 90 degrees clockwise with the aid of the central bushing 18 into the first stage position while the guiding track 19 lowers it from position H to intermediate position G. Dispensing can begin afterwards. The locking plate 14 in its upper position and the slider 15 in its retracted state bearing against the springs 17 seals off the feeder opening 12 of the filled up soft dough receiver 13. On the commencement of feeding, the slider 15 moves outward until the feeder opening 20 is completely open. The feeder sheave 11 dispenses a pre-measured quantity of soft dough onto the frying plate 5 via the feeder opening 12 and the open part in the locking plate 14. The dispensed quantity can be set using any conventional method, so it is not subject to this invention. Once feeding has been finished, the slider 15 retracts and the locking plate 14 closes. Afterwards, the mechanism that actuates the locking plate 14 moves the locking plate 14 downward, against the force of the springs 17, compressing the soft dough dispensed onto the frying plate 5 into the desired shape and size. When this completes, the springs 17 reset the locking plate 14 into its upper position and the soft dough will be on the frying plate 5 ready to be fried.

The frying plate 5 rotates 90 degrees clockwise and horizontally for the next stage. After rotating into position, the frying plate 5 is immersed in the frying oil to the degree allowed by the guiding track 19 (Position J) so that the soft dough can float in the frying oil. Thus one half of the soft dough will be fried in this stage. At the end of the second stage the frying plate 5 is raised up lifting the dough from the frying oil and continues to rise (guiding track 19, Position H) so as to allow it to clear the oil surface when it flips over its own axis by 180 degrees. The two arc-shaped arms 7 of the arrester close like scissors around their axes 6 locking in the half done dough in a cage like fashion.

For stage three the frying plate 5 rotates onward 90 degrees clockwise and flips over 180 degrees around its own horizontal axis. When the flip-over completes, the arrester goes under the dough. Then the cage is immersed in the frying oil (guiding track 19, Position J) so that the half done dough can float in the frying oil while inside the cage. Now the fried side of the dough is on top so the lower half of the dough will be fried in this stage. At the end of the third stage the cage is raised up from the frying pan 32 up to Position H so as to allow it to clear the oil surface when it flips over its own axis by a further 180 degrees or two times 90 degrees.

In stage four the frying plate 5 rotates another 90 degrees clockwise and horizontally. While flipping over any surplus oil drains off the fried dough, the arrester's arms 7 open and the finished fried dough is transferred to the drip tray 36 then from there to the fried dough tray 35 and outside the casing 2. This completes the four-stage frying cycle. Thus frying is implemented in a continuous manner.

1-14. (canceled)

15. A frying unit for frying and flipping food, the frying unit comprising:
a vertical shaft;
a movement mechanism connected to the vertical shaft;
a support column extending radially away from the vertical shaft, having a first end connected to the movement mechanism, and having a second end distant from the vertical shaft;
a frying plate connected to the second end of the support column; and
a frying pan configured to hold frying oil, and
the movement mechanism being configured to move the frying plate in a substantially concentric circle about the vertical shaft while performing the following actions:
lower the frying plate into the frying pan for a first frying of the food,
raise the frying plate out of the frying pan,
rotate the frying plate approximately 180° by rotating the support column to flip the food, and
lower the frying plate into the frying pan for a second frying of the food.

16. The frying unit of claim 15, wherein the movement mechanism includes a guide track concentrically located about the vertical shaft, and wherein the guide track is configured to raise or lower the support column and the connected frying pan as a function of the location of the frying pan in the substantially concentric circle about the vertical shaft.

17. The frying unit of claim 16, wherein the guide track includes at least the following positions:
a loading position configured for loading food into the frying plate,
a first relatively low position configured for the first frying of the food,
a first relatively high position configured for rotating the frying plate approximately 180° by rotating the support column,
a second relatively low position configured for the second frying of the food, and
a second relatively high position configured for rotating the frying plate approximately 180° by rotating the support column.

18. The frying unit of claim 15, wherein the movement mechanism includes a rack configured to rotate the support column about an axis of the support column as the frying pan moves in a substantially concentric circle about the vertical axis.

19. The frying unit of claim 18, wherein the movement mechanism further includes a gear connected to the support column and having gear teeth, wherein the rack includes rack teeth configured to engage the gear teeth and to rotate the support column about the axis of the support column as the frying pan moves in a substantially concentric circle about the vertical axis.

20. The frying unit of claim 19, wherein the frying unit further comprises:
an arrester connected to the flying plate, wherein the arrester includes two arced arms configured for rotation, each arced arm shaped approximately like a segment of a circle.

21. The frying unit of claim 20, wherein the movement mechanism further includes:
an arrester track configured to rotate the two arced arms into arresting positions forming a cage-like enclosure about the food, and
wherein the arrester is configured to: allow the food to float above the flying plate during the first frying, retain the food in the cage-like enclosure during the rotation of the frying plate, and allow the food to float below the frying plate during the second frying, and
wherein each arced arm is approximately 110° to 130° in arc, and fits loosely near a lateral wall of the frying plate when not in an arresting position.

22. The frying unit of claim 15, wherein the frying unit further comprises a first additional support column connected to a first additional frying plate, a second additional support column connected to a second additional frying plate, and a third additional support column connected to a third additional frying plate.

23. The frying unit of claim 22, wherein the support column and the three additional support columns extend radially away from the vertical shaft and are spaced approximately 90° from any adjacent support column or additional support column.

24. The frying unit of claim 23, wherein the frying pan is configured substantially in a pie wedge shape with an angle of slightly over 90° , and is configured to accept at least two of the four flying plates at one time.

25. The flying unit of claim 24, wherein the wedge is configured to extend under the vertical shaft.

26. The frying unit of claim 15, further comprising a heating element configured to heat oil in the frying pan.

27. The frying unit of claim 15, wherein the frying plate is configured to slide along the support column to increase or decrease a distance from the vertical shaft.

28. The frying unit of claim 15, further comprising:
a central rotating bushing around the vertical shaft, and
a guide track proximate to the central rotating bushing and configured to move the supporting column vertically as a function of position of the frying plate in the substantially concentric circle.

29. The frying unit of claim 28, wherein the central rotating bushing has at least one vertical dovetail groove, wherein the support column has a dovetail rib configured to mate with the vertical dovetail groove.

30. The frying unit of claim 29, wherein the central rotating bushing has a lower flange, and wherein the dovetail rib is forced along the dovetail groove and into the guide track by a spring located between the dovetail rib and the lower flange.

31. The frying unit of claim 15, further comprising:
a guide track;
a frying plate bushing connected via a common shaft to a frying plate support carriage, wherein the frying plate bushing is seated, via a ball bearing, in the guide track to lower and raise the frying plate;
a gear, with gear teeth, connected to the support column; and
a rack with rack teeth configured to engage the gear teeth and configured to rotate the support column along a support column axis as the frying plate moves in a substantially concentric circle about the vertical shaft.

32. A frying unit for frying and flipping food, the frying unit comprising:
a vertical shaft;
a movement mechanism connected to the vertical shaft;
a support column extending radially away from the vertical shaft, having a first end connected to the movement mechanism, and having a second end distant from the vertical shaft;
a frying plate connected to the second end of the support column;
a frying pan configured to hold frying oil;
the movement mechanism being configured to move the frying plate in a substantially concentric circle about the vertical shaft while performing the following actions:
(i) lower the frying plate into the frying pan for a first frying of the food,
(ii) raise the frying plate out of the frying pan,
(iii) rotate the frying plate approximately 180° by rotating the support column to flip the food, and
(iv) lower the frying plate into the frying pan for a second frying of the food;
the movement mechanism including a guide track concentrically located about the vertical shaft, and wherein the guide track is configured to raise or lower the support column and the connected frying pan as a function of the location of the frying pan in the substantially concentric circle about the vertical shaft;
the guide track including at least the following positions:
(i) a loading position configured for loading food into the frying plate,
(ii) a first relatively low position configured for the first frying of the food,
(iii) a first relatively high position configured for rotating the frying plate approximately 180° by rotating the support column,
(iv) a second relatively low position configured for the second flying of the food, and
(v) a second relatively high position configured for rotating the frying plate approximately 180° by rotating the support column;
the movement mechanism including a rack configured to rotate the support column about an axis of the support column as the frying pan moves in a substantially concentric circle about the vertical axis;
the movement mechanism further including a gear connected to the support column and having gear teeth, wherein the rack includes rack teeth configured to engage the gear teeth and to rotate the support column about the axis of the support column as the frying pan moves in a substantially concentric circle about the vertical axis;
the frying unit further comprising an arrester connected to the frying plate, wherein the arrester includes two arced arms configured for rotation, each arced arm shaped approximately like a segment of a circle;
the movement mechanism further including an arrester track configured to rotate the two arced aims into arresting positions forming a cage-like enclosure about the food;
the arrester being configured to: allow the food to float above the frying plate during the first frying, retain the food in the cage-like enclosure during the rotation of the frying plate, and allow the food to float below the frying plate during the second frying;
wherein each arced arm is approximately 110° to 130° in arc, and fits loosely near a lateral wall of the frying plate when not in an arresting position;
wherein the frying unit further comprises a first additional support column connected to a first additional frying plate, a second additional support column connected to a second additional frying plate, and a third additional support column connected to a third additional frying plate;
wherein the four support columns extend radially away from the vertical shaft and are spaced approximately 90° from any adjacent support column;
wherein the frying pan is configured substantially in a pie wedge shape with an angle of slightly over 90°, and is configured to accept at least two of the four frying plates at one time; and wherein the wedge is configured to extend under the vertical shaft.

33. The frying unit of claim 32, further comprising:
a central rotating bushing around the vertical shaft,
the central rotating bushing having at least one vertical dovetail groove, and the support column having a dovetail rib configured to mate with the vertical dovetail groove,
the central rotating bushing having a lower flange, and
the vertical dovetail rib being forced along the vertical dovetail groove and into the guide track by a spring located between the vertical dovetail rib and the lower flange.
